(19) United States
(12) Patent Application Publication
(10) Pub. No.: US 2024/0022959 A1
(43) Pub. Date: Jan. 18, 2024

(54) WIRELESS COMMUNICATIONS BALANCING

(71) Applicant: HEWLETT-PACKARD DEVELOPMENT COMPANY, L.P., Spring, TX (US)

(72) Inventors: Chung-Chun Chen, Taipei City (TW); Chih-Ming Huang, Taipei City (TW); Pei-Yi Chiang, Taipei City (TW)

(21) Appl. No.: 17/866,110

(22) Filed: Jul. 15, 2022

(51) Int. Cl. H04W 28/08

(52) U.S. Cl. CPC H04W 28/08

(57) ABSTRACT

An example computing device includes: a first wireless communications interface to communicate via a first protocol; a second wireless communications interface to communicate via a second protocol; a processor to: detect a dock connected to the computing device, the dock capable of supporting wireless communications via the first protocol and the second protocol; select a first subset of first traffic transmitted over the first protocol and a second subset of second traffic transmitted over the second protocol; and transfer the first subset of first traffic and the second subset of second traffic to the dock to balance the wireless communications.

### BACKGROUND

Computing devices may support communications across a variety of protocols, including wired and wireless communications protocols. Wireless communications cause a load on the computing devices, particularly when many communications links are supported, which may cause increased latency, reduced throughput and reduction of quality of the wireless communications.

### BRIEF DESCRIPTION OF THE DRAWINGS

FIG. 1 is a block diagram of an example computing device employing wireless communications balancing.

FIG. 2 is a block diagram of an example system for wireless communications balancing.

FIG. 3 is a block diagram of an example machine-readable storage medium storing instructions for wireless communications balancing.

FIG. 4 is a flowchart of an example method of wireless communications balancing.

FIG. 5 is a block diagram of the system of FIG. 2 after performance of the method of FIG. 4.

FIG. 6 is a flowchart of an example method of evaluating a new wireless communication for wireless communications balancing.

### DETAILED DESCRIPTION

When computing devices, such as laptop or notebook computers, are manufactured with a trend towards slim and clean profiles, their capacity to support wired communications may be limited. Accordingly, computing devices may have an increased reliance on wireless communications, such as Bluetooth communications, WiFi communications, and the like. When a computing device supports many wireless communications, the connections may experience increased latency, reduced throughput and other reductions in quality.

In addition to limiting wired communications, laptop and notebook computers may additionally have limited connection ports for connecting peripheral devices such as display devices, peripheral devices, and the like, and hence the computing devices may be connected to docks, which support connections to other devices, for example by replicating connection ports, and facilitate the transition between the portability of a mobile computing device and the stability of a stationary workstation. The docks, in turn may also have wireless communications capabilities to allow the docked computing device to connect to Bluetooth or WiFi-based devices. Such connections are generally static and based on the previously defined connections.

An example computing device performs wireless communications balancing between itself and a dock connected to the computing device by selecting subsets of different types of wireless traffic and transferring those subsets to be handled by the dock. For example, the types of wireless traffic may be WiFi and Bluetooth traffic and may be classified into real-time and non-real-time traffic. To balance the communications handled by each of the dock and the computing device, the real-time WiFi traffic and the non-real-time Bluetooth traffic may be transferred to the dock while the non-real-time WiFi traffic and the real-time Bluetooth traffic may be maintained at the computing device. In some examples, some further subsets of real-time Bluetooth traffic (e.g., human interface devices) may also be transferred to the dock. Thus, the higher demand real-time traffic is balanced between the dock and the computing device to reduce competition for resources, reduce latency and improve performance. Further, the program detecting the connected dock and performing the transfer may be a daemon program running as a background service.

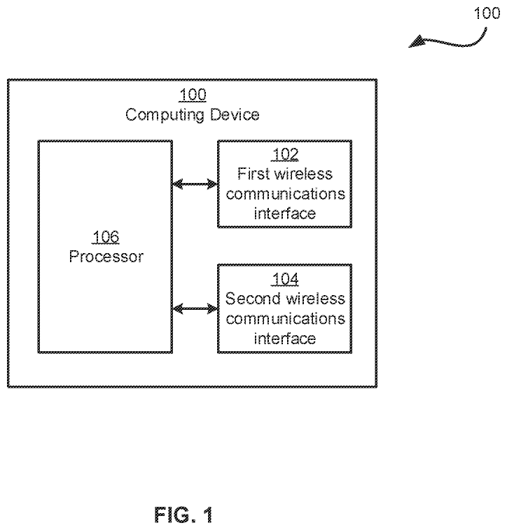

FIG. 1 shows a schematic block diagram of an example computing device 100 employing wireless communications balancing. The computing device 100 may be a mobile computing device such as a laptop computer, a notebook computer, or the like. In particular, the computing device 100 may connect to a dock or other support device (not shown) with which it may balance wireless communications.

The computing device 100 includes a first wireless communications interface 102 to communicate via a first protocol and a second wireless communications interface 104 to communicate via a second protocol. The first and second wireless communications interfaces 102 and 104 may also include suitable hardware (e.g., transmitters, receivers, network interface controllers and the like) allowing the computing device 100 to communicate with other devices. For example, the first wireless communications protocol may be a Bluetooth communications protocol, or another suitable short-range wireless communications protocol, and hence the first wireless communications interface 102 may include a Bluetooth stack. The second wireless communications protocol may be a WiFi communications protocol or another suitable wireless local area network protocol, and hence the second wireless communications interface 104 may include a WiFi stack. In some examples, the first and second wireless communications interfaces 102 and 104 may be integrated as a single communications interface capable of communicating via both the first wireless communications protocol and the second wireless communications protocol.

The computing device 100 further includes a processor 106 interconnected with the first wireless communications interface 102 and the second wireless communications interface 104. The processor 106 may be a microcontroller, a microprocessor, a processing core, or similar device capable of executing instructions. The processor 106 may also include or be interconnected with a non-transitory machine-readable storage medium that may be electronic, magnetic, optical, or other physical storage device that stores executable instructions allowing the processor 106 to perform the functions described herein. In particular, the instructions may cause the processor 106 to detect a dock connected to the computing device 100, select a first subset of first traffic transmitted over the first protocol via the first wireless communications interface 102 and a second subset of second traffic transmitted over the second protocol via the second wireless communications interface 104, and transfer the first subset of first traffic and the second subset of second traffic to the dock to balance the wireless communications to and from the computing device 100.

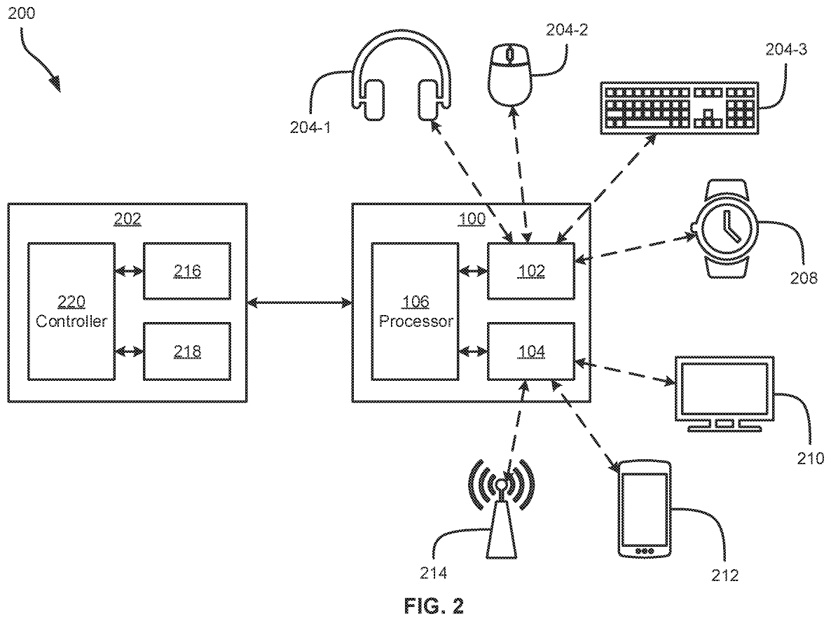

For example, referring to FIG. 2, the computing device 100 may be implemented in an example system 200. The system 200 further includes a dock 202 to which the computing device 100 is connected, as well as several devices connected via wireless communications links.

In the present example, the computing device 100 is connected to human interface devices 204 (HIDs 204), including a headset 204-1, a mouse 204-2, and a keyboard 204-3. In particular, the computing device 100 may communicate with the HIDs 204 over the first protocol (e.g., Bluetooth or other short-range wireless communications), and hence the first wireless communications interface 102 may manage the wireless communications to the HIDs 204. In addition to managing the input and output to the HIDs 204, the computing device 100 may also be in communication with the headset 204-1 via the first protocol to manage a handset profile (HSP) or a hands-free profile (HFP). Generally, the communications between the computing device 100 and the HIDs 204 may be classified as real-time traffic since the computing device 100 and the HIDs 204 exchange information substantially simultaneously and with low latency in order to effectively use the HIDs 204.

The computing device 100 may also communicate with devices or networks in non-real time via the first protocol. For example, the computing device 100 may be connected to a smart watch 208. The communications between the computing device 100 and the smart watch 208 may include periodic updates, for example to a generic attribute profile (GATT) to obtain a battery indication, heart rate monitoring data, or the like. Since the communications is periodic, such communications may be classified as non-real-time traffic.

The computing device 100 may also communicate with devices and/or networks via the second protocol. For example, the computing device 100 may be connected to a television 210 and another computing device 212 via the second protocol (e.g., WiFi or other wireless local area network communications), and hence the second wireless communications interface 104 may manage the wireless communications to the television 210 and the computing device 212. The communications link to the television may be, for example to cast the display of the computing device 100 to the television 210. The communications link to the computing device 212 may be, for example to carry out a voice and/or video call (e.g., via Microsoft Teams, Skype, or the like) and hence may additionally traverse additional networks (e.g., the Internet). Such communications to the television 210 and the computing device 212 may therefore be classified as real-time traffic since the computing device 100 and the television 210 and computing device 212 exchange information substantially simultaneously and with low latency in order to effectively support casting and calling functions.

The computing device 100 may also communicate with devices and/or networks via the second protocol in non-real time. For example, the computing device 100 may be connected to an access point 214, for example to connect to the internet for web browsing or the like. Since the communications may be sporadic, and may also be subject to buffering, such communications may be classified as non-real-time traffic.

The dock 202 may generally be to allow the computing device 100 to connect to other devices, such as a display device, a printer, and the like. The dock 202 may additionally support wireless communications via the first and second protocol to connect, for example to some of the devices 204, 208, 210, 212, and 214.

Thus, the dock 202 may include a respective first communications interface 216 to communicate via the first protocol, a second communications interface 218 to communicate via the second protocol, and a controller 220 interconnected with the first communications interface 216 and the second communications interface 218 to manage the functions thereof.

Sustaining stable communications links to each of the devices 204, 208, 210, 212, and 214 at the computing device 100 may result in a relatively high load on the computing device 100, and hence each of the communications may suffer from latency, reduced throughput (e.g., dropped data packets), instability, and similar. Accordingly, if the dock 202 is capable of supporting some of the communications (i.e., has suitable first and second communications interfaces 216 and 218 for communicating over the first and second protocols, respectively), then the computing device 100 may commence a wireless communications balancing operation to transfer some of the communications to the dock 202.

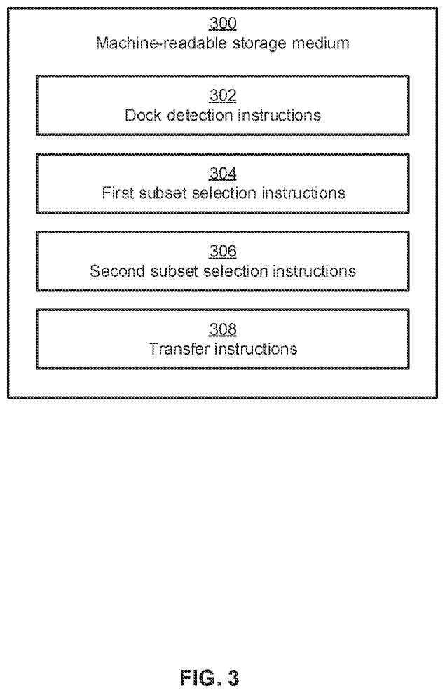

For example, referring to FIG. 3, an example non-transitory machine-readable storage medium 300 storing machine readable instructions is depicted. The storage medium 300 may be an electronic, magnetic, optical, or other physical storage device that stores executable instructions. In particular, the storage medium 300 stores dock detection instructions 302, first subset selection instructions 304, second subset selection instructions 306, and transfer instructions 308. The instructions, when executed by a processor such as the processor 106 of the computing device 100, configure the computing device 100 to transfer wireless communications between the computing device 100 and a connected dock, such as the dock 202, to balance the wireless communications. The instructions stored on the storage medium 300 will be described herein as being executed by the processor 106 in the system 200, but in other examples, other suitable processors or controllers in other suitable systems may execute the instructions on the storage medium 300.

The dock detection instructions 302, when executed, cause the processor 106 to determine whether the computing device 100 is connected to the dock 202. If the processor 106 detects the dock 202 (or another suitable dock), the processor 106 may additionally identify the communications protocols supported by the dock 202. In particular, the processor 106 may determine whether the dock supports the first and second communications protocols.

The first subset selection instructions 304, when executed, cause the processor 106 to select a first subset of first traffic transmitted over the first protocol. That is, the first subset selected by the processor 106 may include a subset of the devices 204 and 208 with which the computing device 100 communicates via the first protocol. For example, the processor 106 may first classify the first traffic over the first protocol into real-time first traffic and non-real-time first traffic. The processor 106 may then select, as the first subset, the non-real-time first traffic. In some examples, the processor 106 may additionally select, as part of the first subset, a further subclass of the real-time first traffic. Other classifications and criteria for selecting the first subset are also contemplated in other examples.

The second subset selection instructions 306, when executed, cause the processor 106 to select a second subset of second traffic transmitted over the second protocol. That is, the second subset selected by the processor 106 may include a subset of the devices 210, 212 and 214 with which the computing device 100 communicates via the second protocol. For example, the processor 106 may classify the second traffic over the second protocol into real-time second traffic and non-real-time second traffic. The processor 106 may then select, as the second subset, the real-time second traffic. Other classifications and criteria for selecting the second subset are also contemplated in other examples.

The transfer instructions 308, when executed, cause the processor 106 to transfer the first subset of first traffic and the second subset of second traffic to the dock 202 to balance the wireless communications. In particular, the first subset may include the non-real-time first traffic while the second subset may include the real-time second traffic, and hence the total load of the real-time traffic and the non-real-time traffic may be balanced amongst the computing device 100 and the dock. To transfer the traffic to the dock 202, the processor 106 may obtain, for each communications link or channel in the first subset and the second subset, connection data for the device (e.g., a media access control (MAC) address of the device) and send the connection data to the dock 202 to connect to the device before disconnecting from the device.

In some examples, the instructions 302, 304, 306, and 308 may be implemented on the computing device 100 as a daemon program operating as a background service.

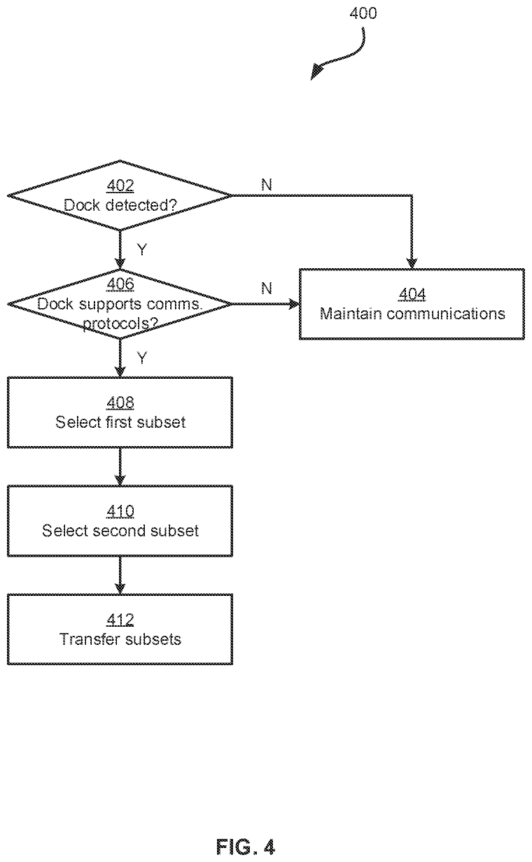

FIG. 4 depicts an example method 400 of wireless communications balancing. The method 400 will be described below in conjunction with its performance by the computing device 100 in the system 200, and in particular by the processor 106 via execution of the instructions stored on the storage medium 300. In other examples, the method 400 may be performed by other suitable devices.

At block 402, the processor 106 determines whether the dock 202 is detected as being connected to the computing device 100. For example, when the instructions 302, 304, 306, and 308 are implemented as a daemon program, the daemon may periodically perform a check to determine whether a new connection to the dock 202 is detected. In particular, the check may be performed automatically as a background service to reduce the impact to the user experience.

If, at block 402, the dock 202 is not detected, then the method 400 proceeds to block 404. At block 404, the processor 106 maintains the wireless communications at the computing device 100 (i.e., as managed by the first and second wireless communications interfaces 102 and 104).

If at block 402, the dock 202 is detected, then the method 400 proceeds to block 406. At block 406, the processor 106 determines whether the dock 202 supports a predefined set of communications protocols. The processor 106 may first identify the communications protocols supported by the dock 202. In particular, the processor 106 may determine whether the dock 202 is capable of communications over the first and second protocols (i.e., as the set of communications protocols). In some examples, if the dock 202 supports one of the protocols but not the other, the determination at block 404 may be negative (i.e., the dock 202 does not support the communications protocols). In other examples, the determination at block 404 may be affirmative if the dock 202 supports at least one of the protocols.

If, at block 404, the processor 106 determines that the dock 202 does not support the communications protocols, then the method 400 proceeds to block 404, where the processor 106 maintains the wireless communications at the computing device 100.

If, at block 404, the processor 106 determines that the dock 202 does support the communications protocols, then the method 400 proceeds to block 408. At block 408, the processor 106 selects a first subset of the first traffic transmitted to and from the computing device 100 over the first protocol. For example, the processor 106 may classify the first traffic as real-time first traffic or non-real-time first traffic. That is, in the system 200, the communications channels to the headset 204-1, the mouse 204-2 and the keyboard 204-3 may be classified as real-time first traffic, while the communications channel to the smart watch 208 may be classified as non-real-time first traffic. The processor 106 may select, as the first subset, the non-real-time first traffic (i.e., the communications channel to the smart watch 208).

In some examples, the processor 106 may additionally identify subclasses of the real-time traffic. The subclasses may be based a type of the end device. For example, since the communication link to the headset 204-1 further supports an HSP or HFP, breaks in communications to the headset 204-1 may cause audio data loss. In contrast, while the communications channels to the mouse 204-2 and the keyboard 204-3 may be classified as real-time traffic, breaks in these communications channels may have a lower impact to the user experience (e.g., a brief lag in response time) than a break in the communication channel to the headset 204-1. Accordingly, in some examples, the processor 106 may additionally select, as part of the first subset, the further subclass of the real-time traffic which can manage a break in connection without substantial data loss (i.e., the subclass containing the mouse 204-2 and keyboard 204-3, as well as other human-interface devices).

In the present example, the types of classifications and subclassifications of the first traffic over the first protocol may be predefined and the processor 106 may follow predetermined rules to select the first subset. In other examples, selection of the first subset may be dynamic, based for example on analysis of the first traffic supported by first wireless communications interface 102 and the load corresponding to each communications channel.

At block 410, the processor 106 selects a second subset of the second traffic transmitted to and from the computing device 100 over the second protocol. For example, the processor 106 may also classify the second traffic as real-time second traffic or non-real-time second traffic. That is, in the system 200, the communications channels to the television 210 and the device 212 may be classified as real-time second traffic, while the communications channel to the access point 214 may be classified as non-real-time second traffic. The processor 106 may select, as the second subset, the real-time second traffic (i.e., the communications channels to the television 210 and the device 212).

In the present example, the types of classifications of the second traffic over the second protocol may be predefined and the processor 106 may follow predetermined rules to select the second subset. In other examples, the processor 106 may additionally apply subclassifications to the real-time or non-real-time traffic, or selection of the second subset may be dynamic based on analysis of the second traffic supported by the second wireless communications interface 104 and the load corresponding to each communications channel. In still further examples, performance of blocks 408 and 410 may be performed dynamically in consideration of one another and the wireless communications supported by each of the wireless communications interfaces 102 and 104.

At block 412, the processor 106 transfers the first subset of the first traffic selected at block 408 and the second subset of the second traffic selected at block 410 to the dock 202. Thus, in the example of FIG. 2, the processor 106 may transfer the wireless communications to the mouse 204-2, the keyboard 204-3, the watch 208 (i.e., as part of the first subset selected at block 408) and the television 210 and the device 212 (i.e., as part of the second subset selected at block 410) to the dock 202.

In particular, for each communications channel or link, the processor 106 may obtain connection data from the end device. The connection data may include a MAC address of the end device, a channel identifier, and any other available information to facilitate establishment of the communications link. The processor 106 may then send the connection data to the dock 202 to allow the dock 202 to establish wireless communications with the end device. In some examples, the processor 106 may additionally transmit instructions to the dock 202 to establish the wireless communications using the connection data. The dock 202 may thus use the connection data to establish the wireless communications rather than initiating a broadcast and/or detection and connection procedure.

The processor 106 may then control the first or second wireless communications interface to disconnect from the device. In some examples, the processor 106 may wait for an indication from the dock 202 that it is connected to the device before disconnecting. In other examples, the processor 106 may disconnect from the device after sending the connection data to the dock 202.

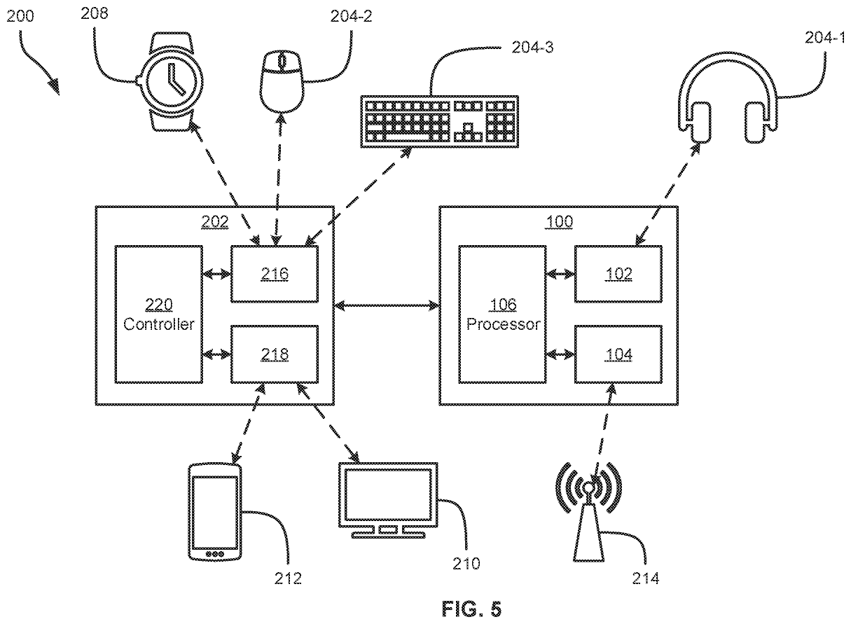

Referring to FIG. 5, a schematic diagram of the system 200 after performance of the method 400 is depicted. In particular, the processor 106 has transferred, as part of the first subset selected at block 408, the mouse 204-2, the keyboard 204-3, and the watch 208 to the dock 202 to manage the wireless communications via the first communications interface 216. Additionally, the processor 106 has transferred, as part of the second subset selected at block 410, the television 210 and the device 212 to the dock 202 to manage the wireless communications via the second communications interface 218. The wireless communications may therefore be better balanced between the dock 202 and the computing device 100, rather than all of the wireless communications being supported by the computing device 100.

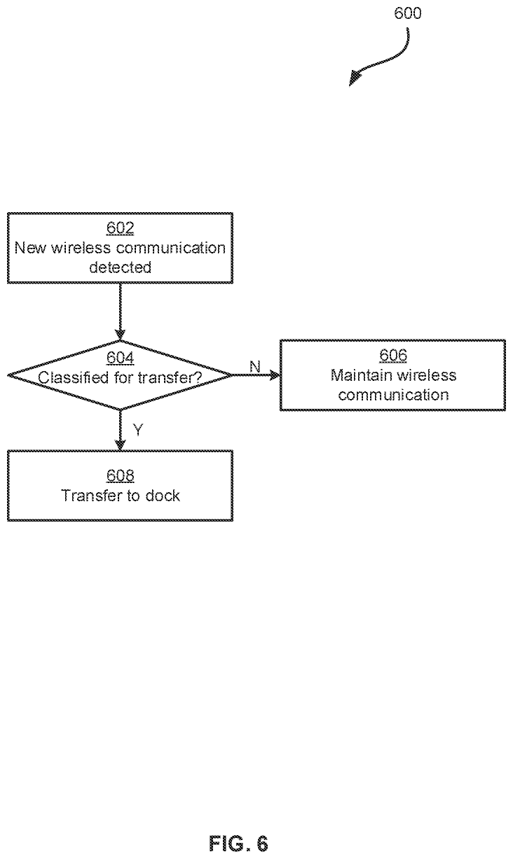

The computing device 100 may similarly evaluate and manage new wireless communications. For example, referring to FIG. 6, an example method 600 of managing a new wireless communication is depicted.

At block 602, the processor 106 detects the new wireless communication. For example, the communication may be to another HID, to another computing device for a file transfer, or similar.

At block 604, the processor 106 determines whether the wireless communication is classified to be transferred to the dock 202. In particular, the processor 106 may make the determination based on the criteria used to select the first subset at block 408 and the second subset at block 410. That is, if the new wireless communication detected at block 602 is non-real-time first traffic, the subclass of real-time first traffic, or real-time second traffic, then the processor 106 may make an affirmative determination at block 604.

If, at block 604, the processor 106 makes a negative determination, that is, that the new wireless communication is not classified for transfer, then the method 600 proceeds to block 606. At block 606, the processor 106 maintains the wireless communication at the computing device 100.

If, at block 604, the processor 106 makes an affirmative determination, then the method 600 proceeds to block 608. At block 608, the processor 106 transfers the wireless communication to the dock 202. In particular, the processor 106 may first obtain connection data for the new wireless communication (e.g., a MAC address or the like for the end device of the wireless communication) and transmits the connection data to the dock 202 to allow the dock 202 to support the wireless communication.

As described above, an example computing device balances wireless communications by selecting subsets of different types of traffic and transferring those subsets to be handled by a dock. In particular, the computing device may separate different sources of real-time (or other high demand) traffic to be balanced between the dock and the computing device.

The scope of the claims should not be limited by the above examples but should be given the broadest interpretation consistent with the description as a whole.

1. A computing device comprising:
a first wireless communications interface to communicate via a first protocol;
a second wireless communications interface to communicate via a second protocol; and
a processor to:
detect a dock connected to the computing device, the dock capable of supporting wireless communications via the first protocol and the second protocol;
select a first subset of first traffic transmitted over the first protocol and a second subset of second traffic transmitted over the second protocol; and
transfer the first subset of first traffic and the second subset of second traffic to the dock to balance the wireless communications.

2. The computing device of claim 1, wherein to select the first subset of first traffic and the second subset of second traffic, the processor is to:
classify the first traffic into real-time first traffic and non-real-time first traffic and select, as the first subset, the non-real-time first traffic; and
classify the second traffic into real-time second traffic and non-real-time second traffic and select, as the second subset, the real-time traffic.

3. The computing device of claim 2, wherein the processor is further to select, as part of the first subset, a further subclass of the real-time first traffic.

4. The computing device of claim 1, wherein the first protocol comprises a Bluetooth communications protocol and the second protocol comprises a WiFi communications protocol.

5. The computing device of claim 1, wherein to transfer the first subset and the second subset to the dock, the processor is to:
for each communications link in the first subset and the second subset, obtain connection data for an end device associated with the communications link; and
send the connection data to the dock to allow the dock to establish a new communications channel to the end device.

6. A non-transitory machine-readable storage medium storing machine-readable instructions, which when executed by a processor of a computing device, cause the processor to:
determine whether the computing device is connected to a dock;
determine whether the dock supports a first communications protocol and a second communications protocol supported by the computing device;
when the dock supports the communications protocols, select a first subset of first traffic transmitted over the first protocol and a second subset of second traffic transmitted over the second protocol; and
transfer the first subset of first traffic and the second subset of second traffic to the dock.

7. The non-transitory machine-readable storage medium of claim 6, wherein the processor determines that the dock supports the communications protocols when the dock supports both the first communications protocol and the second communications protocol.

8. The non-transitory machine-readable storage medium of claim 6, wherein the machine-readable instructions are implemented as a daemon program operating as a background service of the computing device.

9. The non-transitory machine-readable storage medium of claim 8, wherein the daemon program is to cause the processor to periodically determine whether the computing device is connected to the dock.

10. The non-transitory machine-readable storage medium of claim 6, wherein to select the first subset of first traffic and the second subset of second traffic, the processor is to:
classify the first traffic into real-time first traffic and non-real-time first traffic and select, as the first subset, the non-real-time first traffic; and
classify the second traffic into real-time second traffic and non-real-time second traffic and select, as the second subset, the real-time traffic.

11. A method of wireless communications balancing in a computing device, the method comprising:
determining whether a dock is connected to the computing device;
when the dock is detected, determining whether the dock supports a set of communications protocols;
when the dock supports the communications protocols, selecting a first subset of first traffic over a first protocol and a second subset of second traffic over a second protocol; and
transferring the first subset of first traffic and the second subset of second traffic to the dock.

12. The method of claim 11, further comprising:
when the dock is not detected or when the dock does not support the communications protocols, maintaining the wireless communications at the computing device.

13. The method of claim 11, wherein selecting the first subset of first traffic and the second subset of second traffic comprises:
classify the first traffic into real-time first traffic and non-real-time first traffic and select, as the first subset, the non-real-time first traffic; and
classify the second traffic into real-time second traffic and non-real-time second traffic and select, as the second subset, the real-time traffic.

14. The method of claim 13, further comprising selecting, as part of the first subset, a further subclass of the real-time first traffic.

15. The method of claim 11, further comprising:
detecting a new wireless communication;
determining whether the new wireless communication is classified to be transferred based on criteria used to select the first subset and the second subset; and
when the new wireless communication is classified to be transferred, transferring the new wireless communication to the dock.
